(19) United States
(12) Patent Application Publication
(10) Pub. No.: US 2006/0269654 A1
(43) Pub. Date: Nov. 30, 2006

(54) CONSUMABLE SEXUAL PERFORMANCE AID

(76) Inventor: Thomas J. Ali, Scottsdale, AZ (US)

Correspondence Address: WEISS & MOY PC, 4204 NORTH BROWN AVENUE, SCOTTSDALE, AZ, 85251, US

(21) Appl. No.: 11/420,568

(22) Filed: May 26, 2006

Related U.S. Application Data
(60) Provisional application No. 60/685,221, filed on May 27, 2005.

(51) Int. Cl. A23P 1/14

(52) U.S. Cl. 426/302

(57) ABSTRACT

A consumable sexual performance aid comprising edible strip substrate coated with at least one sexual performance-enhancing ingredient. The ingredient may be natural or may comprise a pharmaceutical.

### RELATED APPLICATION

This application claims priority to U.S. Ser. No. 60/685,221, filed May 27, 2005, in the name of the applicant of this application.

### FIELD OF THE INVENTION

The present invention relates generally to sexual performance aids and, more particularly and in one embodiment, to a natural sexual aid that is delivered in an edible film format.

### BACKGROUND OF THE INVENTION

As the success of erectile dysfunction drugs VIAGRA, LEVITRA, CIALIS have shown, there is a great need for digestible supplements that enhance sexual performance. Drugs of this type are marketed to men who suffer from erectile dysfunction. They may also be consumed by men who are capable of normal sexual performance, but who are seek an enhanced sexual experience.

There are a number of important limitations associated with drugs of this type. They require a prescription, they are relatively expensive, and they are non-natural. The can trigger side effects, including headaches, facial flushing, upset stomach, blurred vision, or priapism. They can interact with certain other medications, such as nitrate drugs, and therefore should not be taken by certain patients. In addition, they are delivered in pill form and must be swallowed, which can make them inconvenient for use during, or immediately proceeding, intimacy. Finally, there can be a significant delay between ingestion and response, with a delay of about 30 minutes being typical.

A need exists for a consumable sexual performance aid that, in one embodiment, is natural and therefore non-prescription, and that may be readily digested in a discreet manner. The present invention satisfies these needs and provides other, related, advantages.

### SUMMARY OF THE INVENTION

In accordance with one embodiment of the present invention, a consumable sexual performance aid is disclosed. The aid comprises, in combination: an edible strip substrate; and a sexual performance-enhancing ingredient; wherein the edible strip substrate is coated with the sexual performance-enhancing ingredient.

In accordance with another embodiment of the present invention, a consumable sexual performance aid is disclosed. The aid comprises, in combination: an edible strip substrate; wherein the edible strip substrate is a breath-type strip; and a sexual performance-enhancing ingredient; wherein the edible strip substrate is coated with the sexual performance-enhancing ingredient is one of the group comprising yohimbe bark extract, Sildenafil Citrate, Vardenafil HCI, and Tadalafil.

In accordance with a further embodiment of the present invention, a method for improving sexual performance is disclosed. The method comprises receiving an edible strip substrate coated with a sexual performance-enhancing ingredient; and ingesting the coated edible strip substrate.

### DETAILED DESCRIPTION OF THE PREFERRED EMBODIMENTS

The sexual performance aid of the present invention is provided in an edible strip form. In this regard, in a first step, an edible strip substrate is provided. The edible strip may be a standard breath-type strip. A typical such strip may be comprised of hydroxypropyl methyl cellulose, artificial and natural flavor, tapioca dextrin, canola oil, menthol, maltodextrin—dietary fiber, glycerin, microcrystalline cellulose, gum arabic, acesulfame potassium, sucralose, polysorbate 80, carrageenan, citric acid, and FD&C Red 40 dye. It should be noted that an edible strip formed from some other materials or combination of materials may also be desired.

In a second step, the strip substrate is coated with a composition containing one or more sexual performance-enhancing ingredients. Preferably, the composition is natural, and it may contain two or more sexual performance enhancers.

In a preferred embodiment, the composition contains the following ingredients, which are thought to provide the following listed benefits:

1. Yohimbe bark extract—increases blood flow to the genital area, and may also increase the amount of Cyclic guanosine monophosphate (cGMP). cGMP is a signaling molecule within cells, which plays a role in erectile function by telling the smooth muscle in the corpora cavemosa to relax, which lets blood flow into the chambers and be trapped for an erection.

A clinical study in Rhode Island tested the active ingredient in Yohimbe on a group of men who had experienced chronic sexual dysfunction. For those who had been impotent for less than two years and taking a moderate dosage over a period of one month, there was an improvement rate of 81%. Two out of three patients who had previously experienced partial erections only, and had failed in normal intercourse at least 50% of the time, reported fuller and more lasting erections, leading to consistently successful sex and lovemaking.

2. L-Citrulline—the amino acid Citrulline is a precursor to Arginine, and is involved in the formation of urea in the liver. The synthesis and elimination of urea is essential for removing toxic nitrogen metabolites from the body. Arginine is also the precursor to the polyamines such as cadaverine, putrecine, spermine, and spermidine. These polyamines help stabilize DNA. Arginine is also the precursor to creatine, which is ultimately converted to creatine. This compound is an energy buffer for muscular contraction. Arginine improves circulation, and is sometimes used in the treatment of male sexual health problems and sterility. The amino acid is sometimes used as a sexual stimulant as well.

3. Vitamin B12—also known as cyanocobalamin or cobolamin, it is a very widely researched vitamin, and is used in supplementation to a very large degree. Cobolamin is needed in the manufacture of red blood cells and the maintenance of red blood cells and it stimulates appetite, promotes growth and releases energy. It is often used with the elderly to provide an energy boost, assist in preventing mental deterioration and to speed up thought processes. It is believed by some that it assists with clearing up infections and provides protection against allergies and cancer. This vitamin is also used in the metabolism of fats, proteins and carbohydrates.

4. Cayenne Pepper—It is used as a spice and as a dietary supplement. Cayenne Pepper contains beta-carotene, beta-ionone, citric acid, hesperidin, imonen, lutein, and quercetin. It also contains capsaicin, which is thought to reduce pain and inflammation. When combined with other herbs, Cayenne Pepper has been observed to increase their effectiveness by helping them enter the blood stream faster.

Preferably, the total mass of each strip, including the composition, is approximately 52 mg. Of this amount, approximately 32 to 34 mg is accounted for by the strip substrate. The remaining approximately 18-20 mg is accounted for by the composition. Each particular composition material is preferably provided in about the following amounts: Yohimbe—10 mg; L-Citrulline—6.5 mg; B-12—0.005 mg; and Cayenne Pepper—0.5 mg.

It should be noted that while these mass amounts are preferred, they may be varied without departing from the spirit or scope of the present invention.

It should be apparent from the foregoing that, alternatively, it would be possible to coat the strip-substrate with other sexual performance-enhancing ingredients. This may include, for example, non-natural ingredients. Examples may include erectile dysfunction medications, including Sildenafil Citrate (marketed under name VIAGRA), Vardenafil HCI (marketed under the name LEVITRA), and/or Tadalafil (marketed under the name CIALIS).

While the invention has been particularly shown and described with reference to preferred embodiments thereof, it will be understood by those skilled in the art that the foregoing and other changes in form and details may be made therein without departing from the spirit and scope of the invention.

I claim:

1. A consumable sexual performance aid comprising, in combination:
an edible strip substrate; and
a sexual performance-enhancing ingredient;
wherein the edible strip substrate is coated with the sexual performance-enhancing ingredient.

2. The aid of claim 1 wherein the edible strip substrate is a breath-type strip.

3. The aid of claim 1 wherein the edible strip substrate is comprised of hydroxypropyl methyl cellulose, artificial and natural flavor, tapioca dextrin, canola oil, menthol, maltodextrin—dietary fiber, glycerin, microcrystalline cellulose, gum arabic, acesulfame potassium, sucralose, polysorbate 80, carrageenan, and citric acid.

4. The aid of claim 1 wherein the sexual performance-enhancing ingredient is natural.

5. The aid of claim 1 wherein the sexual performance-enhancing ingredient is one of the group comprising Sildenafil Citrate, Vardenafil HCI, and Tadalafil.

6. The aid of claim 4 wherein the sexual performance-enhancing ingredient comprises yohimbe bark extract.

7. The aid of claim 6 wherein the sexual performance-enhancing ingredient further comprises at least one of L-Citrulline, cobolamin, and cayenne pepper.

8. The aid of claim 7 wherein the sexual performance-enhancing ingredient further comprises each of L-Citrulline, cobolamin, and cayenne pepper.

9. The aid of claim 1 wherein the total mass of the coated edible strip substrate is approximately 52 mg.

10. A consumable sexual performance aid comprising, in combination:
an edible strip substrate;
wherein the edible strip substrate is a breath-type strip; and
a sexual performance-enhancing ingredient;
wherein the edible strip substrate is coated with the sexual performance-enhancing ingredient is one of the group comprising yohimbe bark extract, Sildenafil Citrate, Vardenafil HCI, and Tadalafil.

11. The aid of claim 10 wherein the sexual performance-enhancing ingredient comprises yohimbe bark extract and wherein the sexual performance-enhancing ingredient further comprises at least one of L-Citrulline, cobolamin, and cayenne pepper.

12. The aid of claim 11 wherein the sexual performance-enhancing ingredient further comprises each of L-Citrulline, cobolamin, and cayenne pepper.

13. A method for improving sexual performance comprising:
receiving an edible strip substrate coated with a sexual performance-enhancing ingredient; and
ingesting the coated edible strip substrate.

14. The method of claim 13 wherein the edible strip substrate is a breath-type strip.

15. The method of claim 13 wherein the edible strip substrate is comprised of hydroxypropyl methyl cellulose, artificial and natural flavor, tapioca dextrin, canola oil, menthol, maltodextrin—dietary fiber, glycerin, microcrystalline cellulose, gum arabic, acesulfame potassium, sucralose, polysorbate 80, carrageenan, and citric acid.

16. The method of claim 13 wherein the sexual performance-enhancing ingredient is natural.

17. The method of claim 13 wherein the sexual performance-enhancing ingredient is one of the group comprising Sildenafil Citrate, Vardenafil HCI, and Tadalafil.

18. The method of claim 13 wherein the sexual performance-enhancing ingredient comprises yohimbe bark extract.

19. The method of claim 18 wherein the sexual performance-enhancing ingredient further comprises at least one of L-Citrulline, cobolamin, and cayenne pepper.

20. The method of claim 19 wherein the sexual performance-enhancing ingredient further comprises each of L-Citrulline, cobolamin, and cayenne pepper.
